(19) United States
(12) Patent Application Publication
(10) Pub. No.: US 2026/0195169 A1
(43) Pub. Date: Jul. 9, 2026

(54) PLUGGABLE INTERFACE AND MANAGEMENT TOOL FOR DATA MIGRATION ON MULTITENANT PLATFORM

(71) Applicant: OPEN TEXT HOLDINGS, INC., Menlo Park, CA (US)

(72) Inventors: Arun Kumar Rai, Bangalore (IN); Varun Krishna, Bangalore (IN); Kamani Mohan Chandu, Bangalore (IN)

(21) Appl. No.: 19/011,021

(22) Filed: Jan. 6, 2025

(51) Int. Cl. G06F 9/48; G06F 9/451

(52) U.S. Cl. CPC G06F 9/4856; G06F 9/451

(57) ABSTRACT

A data migration management system functions as a pluggable interface to disparate data migration tools and provides a job management console, a job configuration page, and a dynamic configurable job operation user interface for users of the disparate data migration tools to create, select, manage, and/or delete a data migration job. The job operation user interface is generated on a per job basis based on user-provided information received through the job configuration page and, therefore, is different from job to job. Responsive to an instruction received via the job operation user interface, the data migration management system causes one of the disparate data migration tools to start the data migration job, which entails migrating an application from an application programming interface (API) based source system to an API based target system.

### TECHNICAL FIELD

This disclosure relates generally to data migration. More particularly, this disclosure relates to systems, methods, and computer program products for a pluggable interface and management tool for data migration on a multitenant platform.

### BACKGROUND OF THE RELATED ART

Enterprise data migration is a complex process that varies greatly depending upon the specifics of data involved. Each enterprise data migration operation is a multifaceted challenge that requires a tailored approach to address the unique characteristics of each dataset. For instance, migrating large volumes of data may necessitate a different strategy than migrating smaller, more sensitive datasets. The type of data, whether structured or unstructured, also influences each migration process, as does the variety of data formats and sources.

An enterprise data migration operation can involve people with varying technical backgrounds. Usually, an enterprise data migration team comes up with a custom data migration tool specific to their data migration use case and hand the custom data migration tool over to an operations team to complete the desired data migration. An issue here is that, because the custom data migration tool is developed and provided by the enterprise data migration team, the operations team does not possess the necessary technical understanding of the custom data migration tool.

In view of the foregoing, there is a need for a technical solution that allows an operations team to manage an enterprise data migration operation without requiring deep technical knowledge of the underlying complex data migration process. The invention disclosed herein can address this need and more.

### SUMMARY OF THE DISCLOSURE

A goal of this disclosure is to provide a computer-implemented solution that caters to the migration of application programming interface (API) based applications that have been deployed either in-house (e.g., on the premises of an enterprise) or in a cloud computing environment (which is also referred to as being “in the cloud”). According to embodiments disclosed herein, this goal can be realized in a new data migration management system that functions as a centralized pluggable interface with which disparate API-enabled data migration tools can be connected.

In some embodiments, each of the disparate data migration tools can connect an API-based source system with an API-based target system and perform a data migration job to migrate an application from the API-based source system to the API-based target system. In this way, the data migration management system can be used to carry out and monitor enterprise data migration operations that may involve various types of data migration tools to migrate applications from any API-based source system to any API-based target system.

In some embodiments, the data migration management system can be implemented as a desktop application. In some embodiments, the data migration management system can be implemented as a cloud-hosted application. In some embodiments, the data migration management system can be implemented as a web application that runs in a browser-provided computing environment.

In some embodiments, the data migration management system can facilitate all the workflows provided by each respective data migration tool. The data migration management system also provides a data migration job management console or dashboard for creating and managing multiple enterprise data migration jobs triggered using multiple API-enabled data migration tools. The data migration job management console, which can be dynamically configurable and which can vary from job to job, allows running and monitoring parallel enterprise data migration operations using multiple data migration tools and centrally tracking all the enterprise data migration operations at the same place.

In some embodiments, a system for centralized data migration management may operate on a server machine communicatively connected to disparate data migration tools and to a plurality of user devices associated with users of the disparate data migration tools. The server machine has a processor, a computer-readable medium, and instructions stored on the computer-readable medium for implementing a job management console, a job configuration page, and dynamically configurable a job operation user interface. The instructions are translatable by the processor for receiving, through the job management console, an instruction from one of the users to create a data migration job. Responsive to the instruction, the job configuration page is presented, on a user device communicatively connected to the system over a network, with input data fields for job parameters. The system receives, through the job configuration page, values for the job parameters, the values including a universal resource locator (URL) for starting the data migration job using a first data migration tool of the disparate data migration tools and information about an API based source system and an API based target system. Then, the system dynamically configures, based at least on the information about the API based source system and the API based target system, the job operation user interface. This dynamic configuration can include associating a first user interface element with the URL such that, responsive to the first user interface element associated with the URL being actuated, the system is operable to cause the first data migration tool of the disparate data migration tools to start the data migration job, which comprises migrating an application from the API based source system to the API based target system.

In some embodiments, the system further includes a data store for storing a data migration job configuration file for the data migration job. The data migration job configuration file contains the values for the job parameters, for instance, in the form of key-value pairs for the data migration job.

In some embodiments, the system is operable to generate, on a per job basis and based on user-provided information received through the job configuration page, a data migration job configuration file for each respective application to be migrated, using one of the disparate data migration tools, from one of a plurality of API based source systems to one of a plurality of API based target systems. The user-provided information can include data migration tool details, source details, and destination details. These details are needed because different applications of the plurality of API based source systems reside at different locations (e.g., cloud-hosted versus on-premises) and have different data migration job configuration files. Accordingly, the job operation user interface can differ from one data migration job to another data migration job.

One embodiment comprises a system comprising a processor and a non-transitory computer-readable storage medium that stores computer instructions translatable by the processor to perform a method substantially as described herein. Another embodiment comprises a computer program product having a non-transitory computer-readable storage medium that stores computer instructions translatable by a processor to perform a method substantially as described herein. Numerous other embodiments are also possible.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions, and/or rearrangements may be made within the scope of the disclosure without departing from the spirit thereof, and the disclosure includes all such substitutions, modifications, additions, and/or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 depicts a diagrammatical representation of a distributed network computing environment having a data migration management system that functions as a pluggable interface to a plurality of disparate data migration tools according to some embodiments disclosed herein.

FIG. 2 depicts a diagrammatical representation of an example of a data migration management system according to some embodiments disclosed herein.

FIG. 3 illustrates an example of a job management dashboard according to some embodiments disclosed herein.

FIG. 4 depicts an example view of a jobs page through which job details of individual jobs can be accessed and viewed according to some embodiments disclosed herein.

FIG. 5 is a flow diagram that illustrates an example of a data migration operation according to some embodiments disclosed herein.

FIG. 6 illustrates an example of a dynamically configurable job operation user interface with various user interface elements according to some embodiments disclosed herein.

FIG. 7 depicts an example of a job configuration page with input data fields for job parameters according to some embodiments disclosed herein.

FIG. 8 depicts a diagrammatic representation of a data processing system for implementing an embodiment disclosed herein.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

In the era of technology modernization where all the legacy applications are getting modernized to stay competitive in the fast-paced digital landscape, enterprise data migration becomes a critical activity for smooth transition of users and customers alike. However, it has become increasingly difficult to perform an enterprise data migration operation when source and target (e.g., legacy and modernized) applications are vastly different in the software/hardware architecture, underlying components, and platforms on which they run.

Such vast differences present a technical challenge to migrating an enterprise application and associated data from a legacy system (e.g., an eXtended Markup Language (XML) based system) to a more modern computing environment with minimal or no changes - an approach commonly referred to as Lift and Shift. Ideally, applications are effectively “lifted” from an existing environment and “shifted” as-is to a new hosting premises (i.e., in the cloud). Currently, there are no straight-forward cloud migration approaches like Lift and Shift that can be employed.

As alluded to above, a goal of this disclosure is to provide a computer-implemented solution that caters to the migration of API-based applications. To realize this goal, the computer-implemented solution takes an API-based approach in which an API-based migration operation is performed to transfer enterprise applications and associated data to the cloud from source system APIs to target system APIs. This API-based enterprise data migration method facilitates a seamless transition by ensuring data integrity and continuity of service.

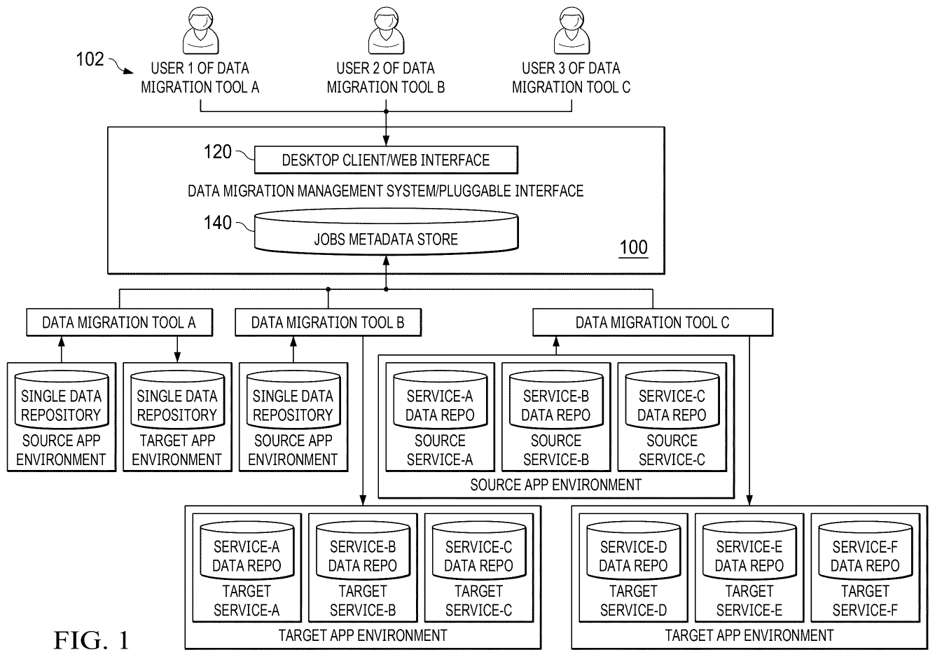

FIG. 1 depicts a diagrammatical representation of a distributed network computing environment having a data migration management system 100 that functions as a pluggable interface to a plurality of disparate data migration tools (e.g., a data migration tool A, a data migration tool B, and a data migration tool C), according to some embodiments disclosed herein.

In some embodiments, the data migration management system 100 can be implemented as a cross-platform desktop application (with a desktop client 120) built using an open-source software framework such as the Electron software framework, available from OpenJS Foundation. Other software frameworks can also be used to build the data migration management system 100. For instance, in some embodiments, the data migration management system 100 can be built on a multitenant Software as a service (SaaS) platform (with a Web interface 120). SaaS allows users to connect to and use cloud-based applications, such as email applications, over the Internet. SaaS is known to those skilled in the art and thus are not further described herein.

At the front end, Hypertext Markup Language (HTML)/Cascading Style Sheets (CSS) can be used for structuring and styling the user interface (UI) components of the data migration management system 100. Further, JavaScript can be used for implementing interactive elements and client-side logic. Software frameworks, HTML, CSS, and JavaScript are known to those skilled in the art and thus are not further described herein.

As illustrated in FIG. 1, each of the plurality of disparate data migration tools is configured for performing data migration jobs in a particular way. For instance, the data migration tool A is configured for transferring an application and associated data from a single data repository in a source application environment to a single data repository in a target application environment; the data migration tool B is configured for transferring an application and associated data from a single data repository in a source application environment to, via data migration services A, B, and C, multiple data repositories in a target application environment; and the data migration tool C is configured for transferring an application and associated data from, via data migration services A, B, and C, multiple data repositories in a source application environment to, via data migration services D, E, and F, multiple data repositories in a target application environment.

In some embodiments, the data migration management system 100 can include a desktop client/Web interface 120 that can be used by various users 102 of the plurality of disparate data migration tools to access the data migration management system 100. Alternatively, a user can access the data migration management system 100 and select a data migration tool to use in a data migration operation. An example of a data migration operation, which includes creating and running/monitoring a job, is described below.

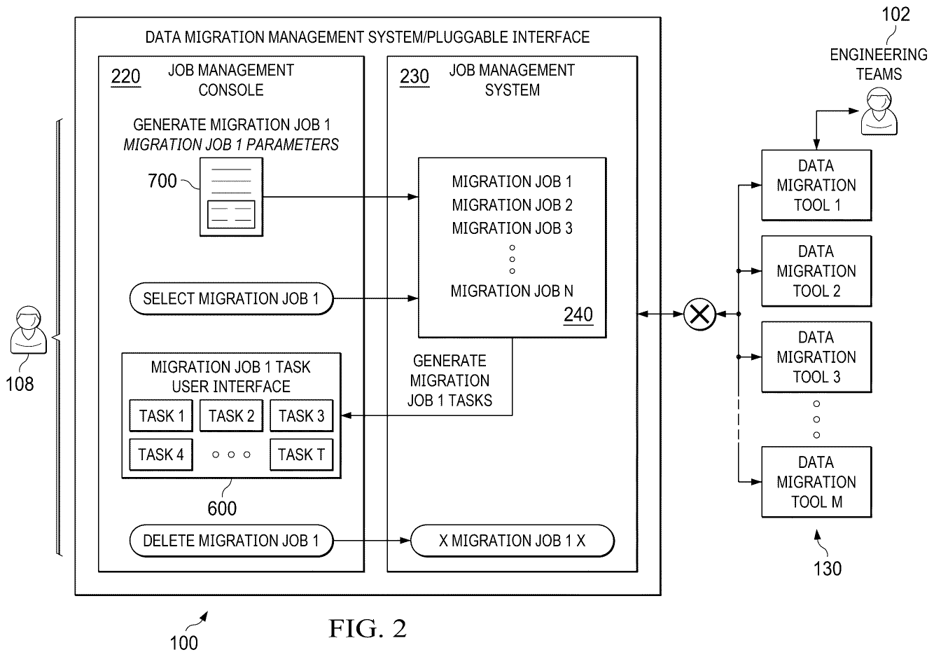

FIG. 2 depicts a diagrammatical representation of a data migration management system 100 having a job management console or dashboard 220 and a job management system 230. In some embodiments, the job management console or dashboard 220 can be implemented as part of the desktop client/Web interface 120 shown in FIG. 1.

In some embodiments, the job management console or dashboard 220 can include a login component that provides a page or form with input data fields such as Tenant Identifier (ID), Client ID, and Client Secret. In some embodiments, the login component functions to validate user credentials using an authentication service available via a cloud computing platform on which the data migration management system runs, ensuring that a logged user is part of a specified tenant of the data migration management system. This tenant can be where a data migration tool (e.g., one of the plurality of data migration tools 130) is hosted.

In some embodiments, the job management system 230 can be communicatively connected to a plurality of disparate data migration tools 130 (which can be selected by any member of engineering teams 102). In this way, the job management console or dashboard 220 can serve as a central place where a migration operation team 108 can interact with the data migration management system 100 and monitor a plurality of migration jobs managed by the job management system 230. The migration operation team 108 can include users with little or no technical background who run migration operations, referred to herein as cloud operations.

In some embodiments, responsive to an instruction received through the job management console or dashboard 220, a job can be created by the job management system 230 with a) migration tool details (i.e., details of a particular migration tool used in a data migration operation) and b) source and destination details (i.e., details of a source system and a target system). As illustrated in FIG. 1, the job thus created can be stored with these different types of details in a jobs metadata repository (e.g., the jobs metadata repository 140).

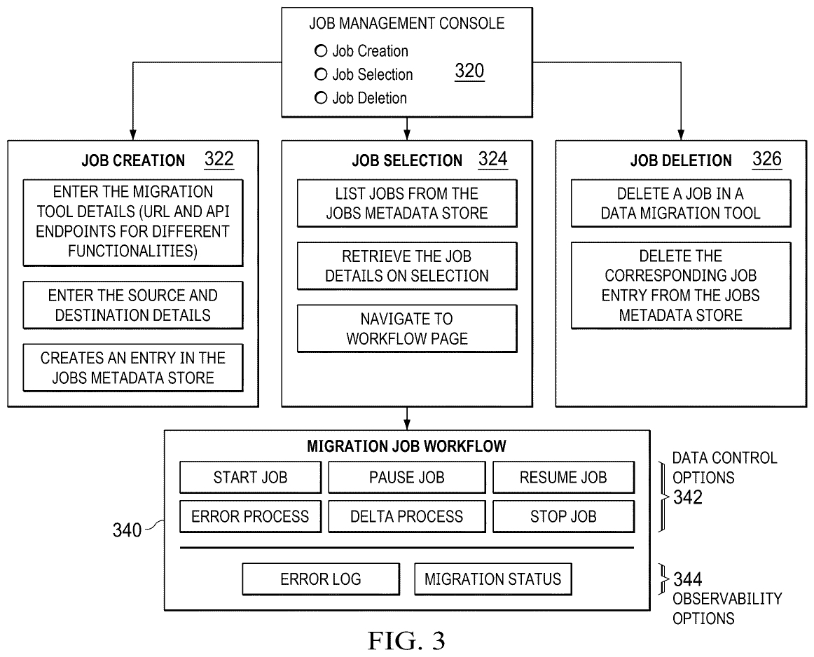

In some embodiments, the job management system 230 includes a migration job workflow module 240 that works with the job management console or dashboard 220. In some embodiments, the job management console or dashboard 220 is configured with functional blocks for creating a job, presenting the job (and/or any or all of the jobs stored in the jobs metadata repository), and deleting the job. These are further described below with reference to FIG. 3.

In some embodiments, as illustrated in FIG. 3, a job management console 320 can be configured with functional blocks 322, 324, 326 for job creation, job selection, and job deletion. The job creation functional block 322 is associated with a view or page that is configured with input fields for a user to enter migration tool details such as an URL, API endpoints, and source and destination details needed to connect a source system and a target system. With user-provided details, the job creation functional block 322 then creates a job and stores it as an entry in the jobs metadata store (e.g., the jobs metadata repository 140 shown in FIG. 1).

Like the job creation functional block 322, the job selection functional block 324 is communicatively connected to the jobs metadata store. The job selection functional block 324 is configured for retrieving information about any job(s) stored in the jobs metadata store and present all the jobs (or a portion thereof) to the user via a jobs page. The job information can, for example, include a job ID and a job creation date associated with each of the jobs in the jobs metadata store.

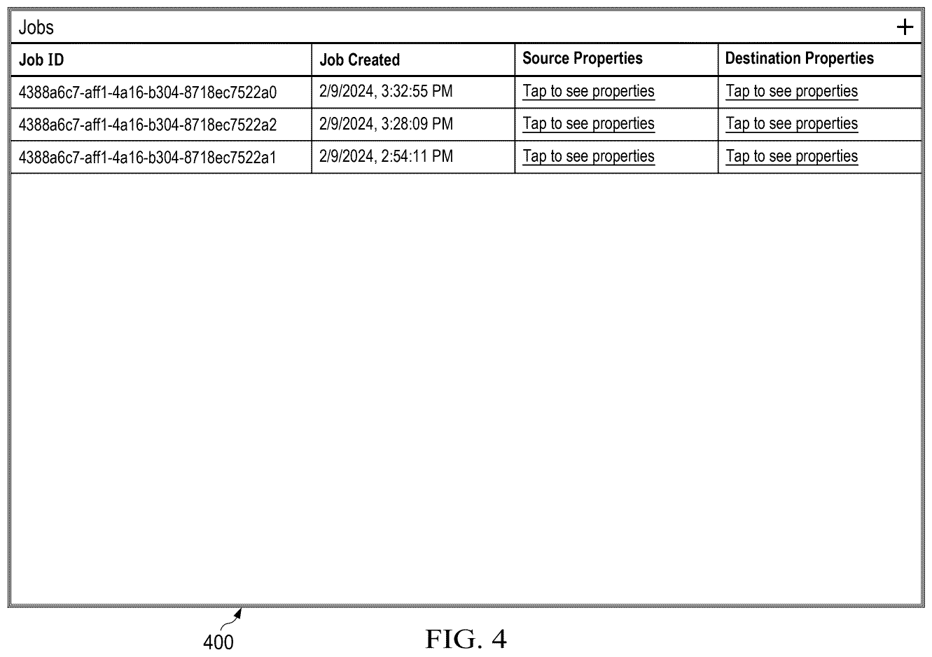

FIG. 4 depicts an example view of a jobs page 400 with a list of jobs identified by job IDs and corresponding job creation date/time. In the example of FIG. 4, the jobs page 400 includes links to job details such as properties of a source system, properties of a target system, etc. In this way, job details of individual jobs can be accessed and viewed. Other ways of presenting job details through the jobs page 400 are also possible. Therefore, the example shown in FIG. 4 is meant to be illustrative and non-limiting.

In some embodiments, the job deletion functional block 326 is configured with a view or page with user interface elements that allow a user to provide an instruction to delete a job in a particular data migration tool. Responsive to the user instruction to delete the job, the job deletion functional block 326 may also delete a corresponding job entry from the jobs metadata store.

Thus, through the job management console 320, a user can create, select, and/or delete a job or jobs. In some embodiments, when a job is deleted, the job is deleted from the migration tool as well as the job metadata repository. When a job is selected (e.g., through a view or page associated with the job selection functional block 324), the user can navigate, or otherwise be directed to, a workflow page. The workflow page is associated with a migration job workflow module 340. As discussed below, the migration job workflow module 340 can provide a variety of user interface elements for data control options 342 as well as observability options 344.

In some embodiments, the data control options 342 can include, but are not limited to, the following:
Start Job—Start the job
Job Status—Fetch the current status of the job. Different job states could be READY, RUNNING or COMPLETED
Work Item Status—Fetch the current status of data entities being migrated. Different states could be PROCESSED, UNPROCESSED and ERROR
Work Item Errors—Fetch the errors with respect to data entities during migration
Pause Job—Pause the job to resume at a later point of time
Resume Job—Start the paused job.
Delta Migration—Trigger the migration of updated entities, which were updated during primary migration.
Send Email—Send a notification email to all the users of the system so as to inform about

the readiness of the new (migrated) application.

In some embodiments, the observability options 344 can include, but are not limited to, the following:
Migration Status—Details on the data entities migrated as well as those under process.
Error Log Display—Errors with respect to data entities which failed to get migrated.

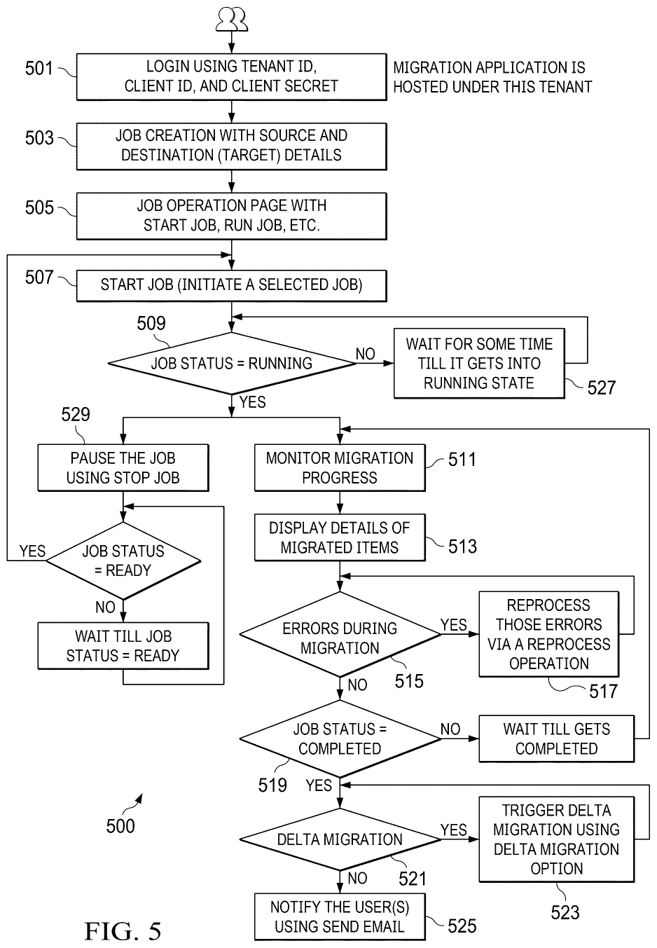

FIG. 5 is a flow diagram that illustrates an example of a data migration operation 500 performed by a migration job workflow module (e.g., the migration job workflow module 340). The migration job workflow module is configured for performing a variety of operations for managing and monitoring a job's progress as well as handling any errors that may occur.

In the example of FIG. 5, a user logs into a desktop client/web interface (501) using a tenant ID, client ID, and client secret (e.g., one or more security questions such as the name of a high school mascot, the name of the youngest child in the family, etc.). The user creates a job (e.g., through the job management console 320 shown in FIG. 3) with source and destination details (503) and is directed to a workflow page (e.g., a job operation user interface) with options such as start a job, etc. (505). In response to a user instruction to start a job, a job is initiated (507).

For each job that is running (509), the user can monitor the migration progress (511) by viewing details of migrated items displayed, e.g., on the workflow page (513). If an error (or errors) occurred during the migration (515), those errors can be reprocessed via a reprocess operation (517).

In some embodiments, when the job is completed (519), delta migration is checked (521). Where applicable, a delta migration is performed using a delta migration option (523). Otherwise, the user(s) is/are notified (e.g., by email) (525). As illustrated in FIG. 5, the job can be delayed (527) or paused while it's running (529).

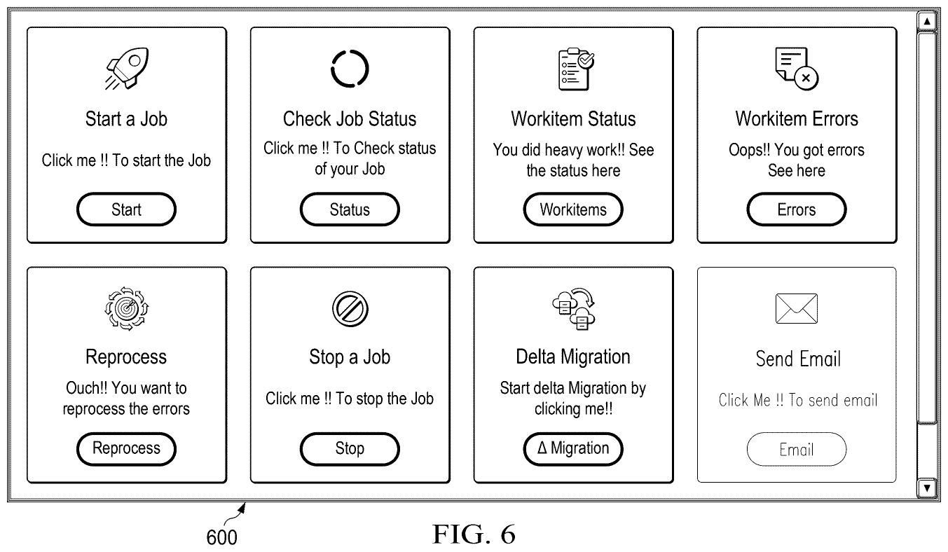

FIG. 6 illustrates an example of a job operation user interface 600 with various user interface elements according to some embodiments disclosed herein. The job operation user interface 600 is dynamically configurable and generated on a per job basis based on information provided in a migration job configuration file. The migration job configuration file, which is created on a per job basis (e.g., by the job creation functional block 322 shown in FIG. 3), contains user-provided information such as migration tool details, source details, destination (target) details, etc. As discussed above, both the source system and the target system are API-based systems. In some embodiments, a migration job configuration file contains key-value pairs for a particular job (as provided by an owner of the application to be migrated).

That is, each migration job configuration file corresponds to an application that is to be migrated from one place (i.e., an API based source system) to another (i.e., an API based target system). Different applications may reside at different locations and have different migration job configuration files. Accordingly, migration job configuration files may also reside at different locations. Once the data migration management system has the necessary information (e.g., which data migration tool, what source system, what target system, etc.) in a migration job configuration file, a job is created and, correspondingly, a job operation user interface is also created based on information contained in the migration job configuration file. In this way, job operation user interfaces may differ from migration job to migration job. As a non-limiting example, delta migration could optionally be a functional block or user interface element shown in a job operation user interface.

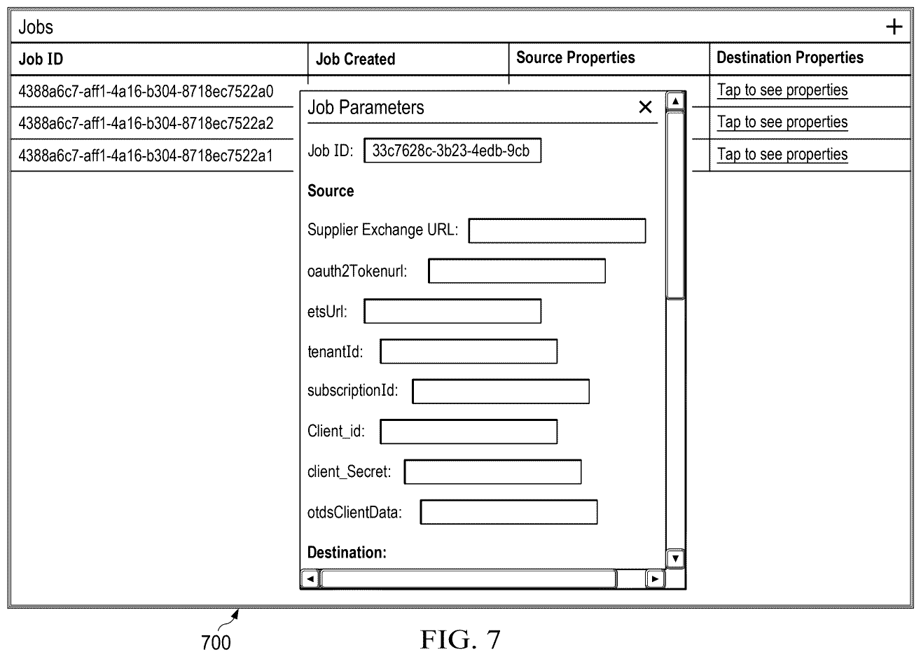

FIG. 7 depicts an example of a job configuration page 700 with input data fields for job parameters according to some embodiments disclosed herein. User-provided details of a job are received through these input data fields and stored in the configuration file which is then used to generate a job operation user interface (e.g., the job operation user interface 600 shown in FIG. 6) dynamically.

When a migration job is complete, a notification is sent to the engineer (e.g., by email). The user can then verify that the migration job is complete and handle any end issues. An engineer starts a migration job using the dynamically configurable job operation user interface, monitors the progress, and verifies whether a job is complete without errors.

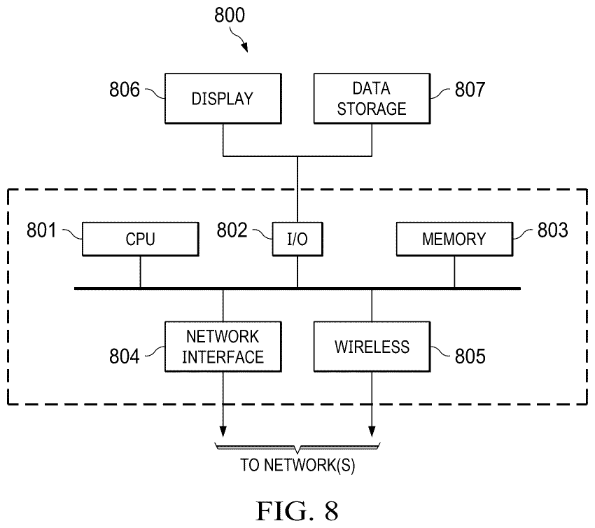

FIG. 8 depicts a diagrammatic representation of a data processing system for implementing an embodiment disclosed herein. As shown in FIG. 8, data processing system 800 may include one or more central processing units (CPU) or processors 801 coupled to one or more user input/output (I/O) devices 802 and memory devices 803. Examples of I/O devices 802 may include, but are not limited to, keyboards, displays, monitors, touch screens, printers, electronic pointing devices (for example, mouse, trackball, stylus, touch pad, etc.), or the like.

Embodiments discussed herein can be implemented in a computer communicatively coupled to a network (for example, the Internet), another computer, or in a standalone computer. As is known to those skilled in the art, a suitable computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device.

Examples of memory devices 803 may include, but are not limited to, hard drives (HDs), magnetic disk drives, optical disk drives, magnetic cassettes, tape drives, flash memory cards, random access memories (RAMs), read-only memories (ROMs), smart cards, etc. Data processing system 800 can be coupled to display 806, information device 807 and various peripheral devices (not shown), such as printers, plotters, speakers, etc. through I/O devices 802. Data processing system 800 may also be coupled to external computers or other devices through network interface 804, wireless transceiver 805, or other means that is coupled to a network such as a local area network (LAN), wide area network (WAN), or the Internet.

Those skilled in the relevant art will appreciate that the invention can be implemented or practiced with other computer system configurations, including without limitation multi-processor systems, network devices, mini-computers, mainframe computers, data processors, and the like. The invention can be embodied in a computer or data processor that is specifically programmed, configured, or constructed to perform the functions described in detail herein. The invention can also be employed in distributed computing environments, where tasks or modules are performed by remote processing devices, which are linked through a communications network such as a local area network (LAN), wide area network (WAN), and/or the Internet.

In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory computer-readable medium, hardware circuitry or the like, or any combination and that may be translatable by one or more server machines. Examples of a non-transitory computer-readable medium are provided below in this disclosure.

ROM, RAM, and HD are computer memories for storing computer-executable instructions executable by the CPU or capable of being compiled or interpreted to be executable by the CPU. Suitable computer-executable instructions may reside on a computer-readable medium (e.g., ROM, RAM, and/or HD), hardware circuitry or the like, or any combination thereof. Within this disclosure, the term “computer-readable medium” is not limited to ROM, RAM, and HD and can include any type of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like.

The processes described herein may be implemented in suitable computer-executable instructions that may reside on a computer-readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code any of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more digital computers, by using application specific integrated circuits, programmable logic devices, field programmable gate arrays, optical, chemical, biological, quantum or nanoengineered systems, components and mechanisms may be used. The functions of the invention can be achieved in many ways. For example, distributed or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer-readable medium can be, by way of example only but not by limitation, an electronic, magnetic, optical, electromagnetic, infrared, or semiconductor system, apparatus, system, device, propagation medium, or computer memory. Such computer-readable medium shall be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer-readable media storing computer instructions translatable by one or more processors in a computing environment.

A “processor” includes any hardware system, mechanism or component that processes data, signals or other information. A processor can include a system with a central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Further, portions of processing can be performed at different times and at different locations, by different (or the same) processing systems.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein, the meaning of “in” includes “in” and “on” unless the context clearly dictates otherwise.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted. The scope of the invention should be determined by the following claims and their legal equivalents.

What is claimed is:

1. A system for centralized data migration management, the system comprising:
a server machine communicatively connected to disparate data migration tools and to a plurality of user devices associated with users of the disparate data migration tools, the server machine having a processor, a computer-readable medium, and instructions stored on the computer-readable medium;
a job management console;
a job configuration page; and
a job operation user interface;
wherein the instructions are translatable by the processor for:
receiving, through the job management console, an instruction from one of the users to create a data migration job;
presenting, on a user device communicatively connected to the system over a network, the job configuration page with input data fields for job parameters;
receiving, through the job configuration page, values for the job parameters, the values including a universal resource locator (URL) for starting the data migration job using a first data migration tool of the disparate data migration tools and information about an application programming interface (API) based source system and an API based target system;
dynamically configuring, based at least on the information about the API based source system and the API based target system, the job operation user interface, wherein the dynamically configuring comprises associating a first user interface element with the URL; and
presenting the job operation user interface thus dynamically configured with the first user interface element on the user device, wherein the instructions are further translatable by the processor for, responsive to the first user interface element associated with the URL being actuated, causing the first data migration tool of the disparate data migration tools to start the data migration job, and wherein the data migration job comprises migrating an application from the API based source system to the API based target system.

2. The system of claim 1, further comprising:
a data store for storing a data migration job configuration file for the data migration job, the data migration job configuration file containing the values for the job parameters.

3. The system of claim 1, wherein the instructions are further translatable by the processor for generating, on a per job basis and based on user-provided information received through the job configuration page, a data migration job configuration file for each respective application to be migrated, using one of the disparate data migration tools, from one of a plurality of API based source systems to one of a plurality of API based target systems.

4. The system of claim 3, wherein the user-provided information includes data migration tool details, source details, and destination details.

5. The system of claim 3, wherein different applications of the plurality of API based source systems reside at different locations and have different data migration job configuration files.

6. The system of claim 3, wherein the job operation user interface is dynamically configurable based on the user-provided information such that the job operation user interface differs from one data migration job to another data migration job.

7. The system of claim 1, wherein the data migration job configuration file contains key-value pairs for the data migration job.

8. A method for centralized data migration management, the method comprising:
receiving, through a job management console of a data migration management system, an instruction from one of the users to create a data migration job, the data migration management system operating on a server machine communicatively connected to disparate data migration tools and to a plurality of user devices associated with users of the disparate data migration tools, the server machine having a processor, a computer-readable medium, and instructions stored on the computer-readable medium;
presenting, on a user device communicatively connected to the data migration management system over a network, a job configuration page of the data migration management system with input data fields for job parameters;
receiving, through the job configuration page of the data migration management system, values for the job parameters, the values including a universal resource locator (URL) for starting the data migration job using a first data migration tool of the disparate data migration tools and information about an application programming interface (API) based source system and an API based target system;
dynamically configuring, based at least on the information about the API based source system and the API based target system, a job operation user interface of the data migration management system, wherein the dynamically configuring comprises associating a first user interface element with the URL; and
presenting the job operation user interface thus dynamically configured with the first user interface element on the user device, wherein the data migration management system, responsive to the first user interface element associated with the URL being actuated, causes the first data migration tool of the disparate data migration tools to start the data migration job, and wherein the data migration job comprises migrating an application from the API based source system to the API based target system.

9. The method according to claim 8, further comprising:
storing a data migration job configuration file for the data migration job in a data store, the data migration job configuration file containing the values for the job parameters.

10. The method according to claim 8, further comprising:
generating, on a per job basis and based on user-provided information received through the job configuration page, a data migration job configuration file for each respective application to be migrated, using one of the disparate data migration tools, from one of a plurality of API based source systems to one of a plurality of API based target systems.

11. The method according to claim 10, wherein the user-provided information includes data migration tool details, source details, and destination details.

12. The method according to claim 10, wherein different applications of the plurality of API based source systems reside at different locations and have different data migration job configuration files.

13. The method according to claim 10, wherein the job operation user interface is dynamically configurable based on the user-provided information such that the job operation user interface differs from one data migration job to another data migration job.

14. The method according to claim 8, wherein the data migration job configuration file contains key-value pairs for the data migration job.

15. A computer program product for centralized data migration management, the computer program product comprising a computer-readable medium storing instructions translatable by a data migration management system operating on a server machine communicatively connected to disparate data migration tools and to a plurality of user devices associated with users of the disparate data migration tools, wherein the instructions are translatable by the data migration management system for:
receiving, through a job management console of the data migration management system, an instruction from one of the users to create a data migration job;
presenting, on a user device communicatively connected to the data migration management system over a network, a job configuration page of the data migration management system with input data fields for job parameters;
receiving, through the job configuration page of the data migration management system, values for the job parameters, the values including a universal resource locator (URL) for starting the data migration job using a first data migration tool of the disparate data migration tools and information about an application programming interface (API) based source system and an API based target system;
dynamically configuring, based at least on the information about the API based source system and the API based target system, a job operation user interface of the data migration management system, wherein the dynamically configuring comprises associating a first user interface element with the URL; and
presenting the job operation user interface thus dynamically configured with the first user interface element on the user device, wherein the data migration management system, responsive to the first user interface element associated with the URL being actuated, causes the first data migration tool of the disparate data migration tools to start the data migration job, and wherein the data migration job comprises migrating an application from the API based source system to the API based target system.

16. The computer program product of claim 15, wherein the instructions are translatable by the data migration management system for:
storing a data migration job configuration file for the data migration job in a data store, the data migration job configuration file containing the values for the job parameters.

17. The computer program product of claim 15, wherein the instructions are translatable by the data migration management system for:
generating, on a per job basis and based on user-provided information received through the job configuration page, a data migration job configuration file for each respective application to be migrated, using one of the disparate data migration tools, from one of a plurality of API based source systems to one of a plurality of API based target systems.

18. The computer program product of claim 17, wherein the user-provided information includes data migration tool details, source details, and destination details.

19. The computer program product of claim 17, wherein different applications of the plurality of API based source systems reside at different locations and have different data migration job configuration files.

20. The computer program product of claim 17, wherein the job operation user interface is dynamically configurable based on the user-provided information such that the job operation user interface differs from one data migration job to another data migration job.
